(19) United States
(12) Patent Application Publication
(10) Pub. No.: US 2018/0357931 A1
(43) Pub. Date: Dec. 13, 2018

(54) BIO-MODEL COMPRISING A SENSOR AND METHOD OF MANUFACTURING A BIO-MODEL COMPRISING A SENSOR

(71) Applicant: UNIVERSITI MALAYA, Kuala Lumpur (MY)

(72) Inventors: Vickneswaran A/L MATHANESWARAN, Kuala Lumpur (MY); Zainal Ariff Bin ABDUL RAHMAN, Kuala Lumpur (MY); Yuwaraj Kumar A/L BALAKRISHNAN, Kuala Lumpur (MY); Su Tung TAN, Kuala Lumpur (MY)

(73) Assignee: UNIVERSITI MALAYA, Kuala Lumpur (MY)

(21) Appl. No.: 15/776,705

(22) PCT Filed: Nov. 18, 2016
(86) PCT No.: PCT/MY2016/050078

§ 371 Date: May 16, 2018

(30) Foreign Application Priority Data
Nov. 18, 2015 (MY) PI 2015002773

(51) Int. Cl. G09B 23/30

(52) U.S. Cl. CPC G09B 23/30

(57) ABSTRACT

According to a first aspect of the present invention there is provided a three dimensional bio-model for simulating a surgical procedure. The bio-model comprises a synthetic anatomical structure and a sensor configured to sense a quantity indicative of a characteristic of the simulated surgical procedure. The bio-model may be manufactured based on medical image data using three-dimensional printing.

### FIELD OF THE INVENTION

Embodiments of the present invention relate to three dimensional bio-models of anatomical structures comprising representations of features such as organs and tumors for use in simulating or practicing surgical procedures; and the manufacture of such bio-models.

### BACKGROUND OF THE INVENTION

Surgery is a difficult discipline to master. In order to develop and perfect their surgical skills, trainees and junior surgeons must repeatedly practice surgical procedures. Traditionally trainee surgeons have used cadavers to develop and practice their technique. The use of cadavers presents a number of issues: in many countries the use of cadavers is restricted for ethical and religious reasons; and the cost associated with preservation and disposal of is high. Further, in order to simulate many medical procedures an accurate representation of a specific pathology is required. An example of this is the simulation of the procedure required for the removal of a tumor. In such a case, the position, orientation, size and nature of the tumor will be unique to the pathology of a specific patient. Therefore a simulation based on a normal anatomy without the tumor will be of little or no benefit in for a surgeon preparing for the removal of a tumor.

Recent developments in three-dimensional printing techniques allow the production of three-dimensional bio-models of parts of the human anatomy which can assist surgeons in practicing their technique. The production of bio-models by these techniques allows accurate representations of the human body to be produced. The bio-models may be based on a specific patient and include accurate representations of the anatomy specific to that patient. Surgeons may use such bio-models to simulate and plan surgeries for specific patients as well as to practice general surgical techniques.

### SUMMARY OF THE INVENTION

According to a first aspect of the present invention there is provided a three dimensional bio-model for simulating a surgical procedure. The bio-model comprises a synthetic anatomical structure and a sensor configured to sense a quantity indicative of a characteristic of the simulated surgical procedure.

The sensor may be a proximity sensor, a motion sensor, a pressure sensor or other type of sensor. The incorporation of a sensor or a number of sensors into the bio-model provides a three dimensional structure that accurately simulates an actual human anatomy and additionally provides an interactive learning model. The output of the sensors may be provided to the user, for example a trainee surgeon in real time or may be provided to the user after the simulated surgical procedure is completed.

The sensor may detect the presence of a probe. This could be during a simulated biopsy or drilling procedure. Thus a motion sensor or proximity could detect the depth reached by the probe during a simulated surgical procedure.

The sensor may detect the pressure exerted by the probe, for example in a procedure that causes increases in pressure.

The sensor may detect leakage of fluid, this could detect internal bleeding or hemorrhage during a simulated surgical procedure. In such embodiments, the bio-model may include a fluid reservoir or fluid system arranged to simulate the circulatory system of a patient.

The sensor may comprise a wireless interface which allows communication with a computer or other electronic device. The wireless interface may be configured communicate using any wireless communication protocol such as the Bluetooth protocol.

In an alternative embodiment, the sensors may be wired sensors connected to a computer or other device by wires.

In an embodiment, the bio-model comprises two parts: a base part and an insert which fits in a slot in the base part. The insert comprises the synthetic anatomical structure and the fluid system.

The insert provides an accurate representation of the internal anatomy which may be cut or otherwise changed during a simulated procedure. Therefore, the insert can only be used for one simulated procedure. Since the base part is not altered during a simulated procedure it can be reused. Therefore only the insert is discarded following a simulated procedure. This reduces the cost of each individual simulation since only the insert must be replaced.

The surface of the base part may accurately represent the surface of a part of a body such as a head or torso. This allows surgical navigation systems to be used during the simulated surgical procedure. Surgical navigation systems such as the Medtronic StealthStation S7 System use optical navigation cameras to assist a surgeon during surgery. The provision of a base part which accurately reproduces the surface features in an area around the simulated procedure location allows the use of the navigation system to be incorporated in the simulation of the surgical procedure.

Alternatively, the three dimensional bio-model may be produced as a single part.

According to a second aspect of the present invention, there is provided a method of manufacturing a three dimensional bio-model. The method comprises receiving medical image data for an anatomical structure. The medical image data may be captured from medical imaging apparatus such as a magnetic resonance imaging (MRI) apparatus, a computed tomography (CT) apparatus, an x-ray imaging apparatus, or an ultrasound apparatus. A three dimensional model is generated for the anatomical structure from the medical image data. Three dimensional bio-model structure data is then generated from the three dimensional structure data. The bio-model structure data is then three dimensional printed to provide a three dimensional bio-model structure. Then, a sensor is placed in the three dimensional bio-model structure.

The use of three dimensional printing technology allows a bio-model to be produced that accurately represents the anatomy of a patient and the pathology of any diseases from which the patient is suffering.

The medical image data may be segmented. The segmentation may provide labels indicating parts of the anatomical structure. This segmentation may be applied by a clinician or may be automatically applied using image recognition software.

The bio-model may be printed as a plurality of separate parts which are assembled to form the complete bio-model.

Sensor space data indicating a sensor space may be added to the three dimensional structure data when generating the three dimensional bio-model structure data. When the bio-model structure data is three dimensional printed to provide a three dimensional bio-model structure, the three dimensional bio-model structure comprises a sensor space.

Embodiments provide an anatomical model which permits the assessment of skin, tissues, structures, regions, bones and joints. The bio-model may possess similar properties such as thickness, feel or color to an actual organ or anatomy.

### BRIEF DESCRIPTION OF THE DRAWINGS

In the following, embodiments of the present invention will be described as non-limiting examples with reference to the accompanying drawings in which:

FIG. 1 shows a bio-model for simulating a surgical procedure;

FIG. 2 shows a bio-model according to an embodiment of the present invention;

FIG. 3 shows a bio-model according to an embodiment of the present invention;

FIG. 4 shows a bio-model which comprises an insert according to an embodiment of the present invention;

FIG. 5 shows a bio-model according to an embodiment of the present invention which comprises a base piece and an insert; and

FIG. 6 is a flow chart showing a method of manufacturing a bio-model according to an embodiment of the present invention.

### DETAILED DESCRIPTION

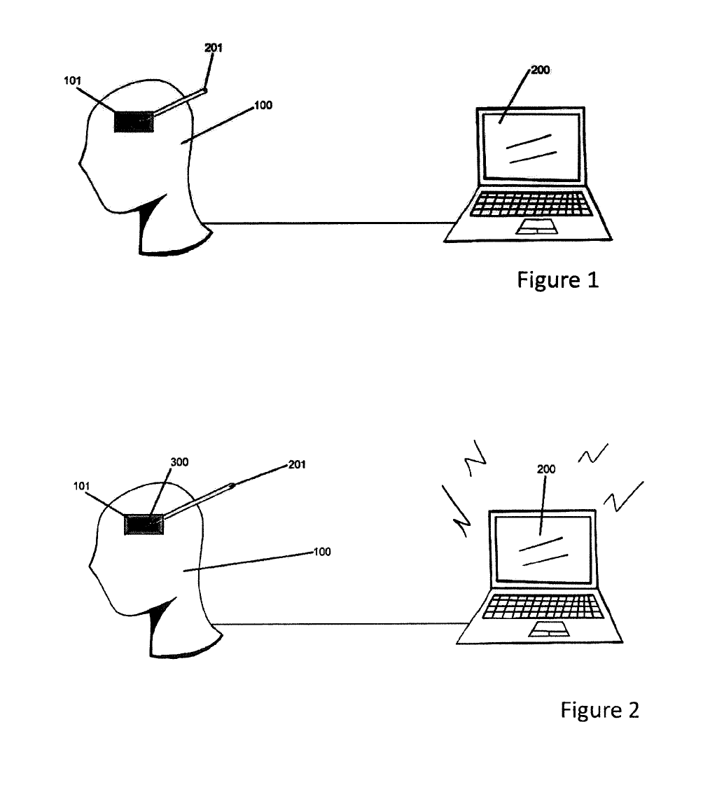

FIG. 1 shows an example of a bio-model 100. The bio-model 100 comprises an insert 101 which has an internal structure that mimics the internal anatomy of a patient. In this example, the bio-model 100 represents a human head and the insert 101 recreates the internal structure of part of the human head to simulate a surgical procedure. During the simulated surgical procedure, a probe 201 is inserted into the insert 101. The probe 201 may be a needle for injecting or extracting fluid from the bio-model 100. The probe 201 may be a scalpel or other surgical tool which is used during a surgical procedure. As shown in FIG. 1, the bio-model 100 is coupled to a computer 200 which records or displays aspects of a simulated surgical procedure.

FIG. 2 shows a bio-model 100 according to an embodiment of the present invention. As described above in relation to FIG. 1, the bio-model 100 comprises an insert 101. In the embodiment shown in FIG. 2, the insert 101 comprises a sensor 300 which senses a characteristic of the surgical procedure. The sensor 300 is coupled to the computer 200. This allows the computer 200 to record or display information on the simulated surgical procedure. In an embodiment, the connection between the sensor 300 and the computer 200 may be a wireless connection. In an embodiment, the sensor 300 comprises a wireless network interface which allows communication with the computer 200 using a wireless network protocol such as Bluetooth. In an alternative embodiment, the connection between the sensor 300 and the computer 200 is a wired connection.

The sensor 300 may be, for example a motion sensor, a pressure sensor, a humidity sensor, a vibration sensor, a leakage sensor, a heat sensor, or a temperature sensor. The sensor 300 monitors a characteristic of the simulated surgical procedure. In one embodiment, the computer 200 may give the user instant feedback during the simulated surgical procedure, for example by sounding an alarm. In another embodiment, the computer 200 may record characteristics of the surgical procedure, such as the values output by the sensor 300 during the simulated surgical procedure and provide the values to the user for review once the procedure was completed.

In an embodiment, the sensors may be motion sensors or depth sensors that detect depth of the probe insertion during a simulated biopsy or drilling procedure. The sensors may be pressure sensor for procedures with conditions that may involve pressure or that may cause increase of pressure. The sensors may be leakage sensors in procedures which rupture of a vessel such as internal bleeding or hemorrhage may occur.

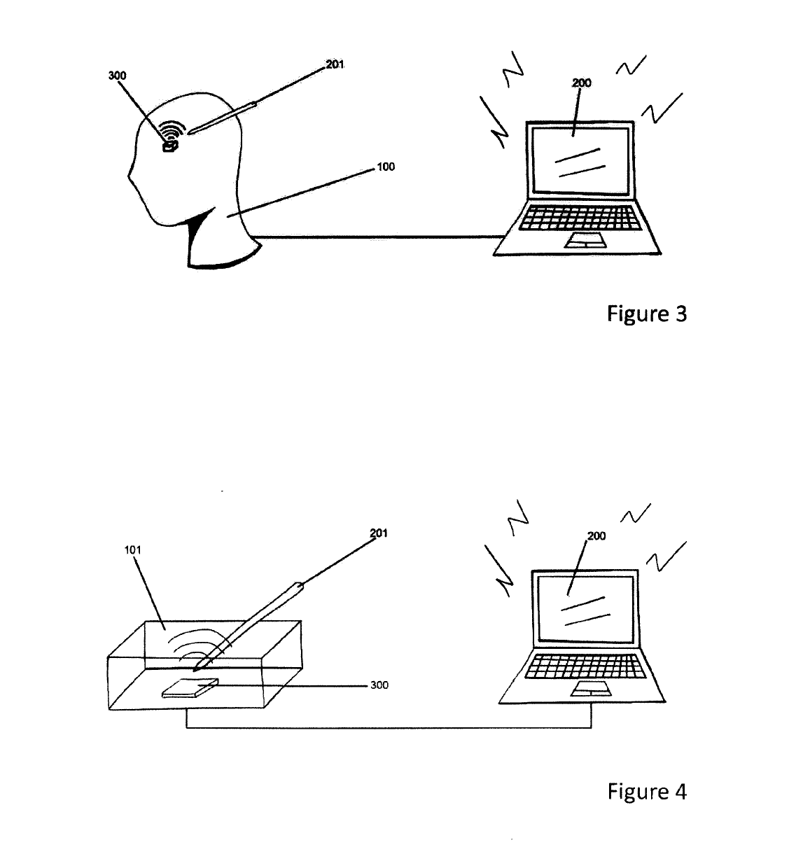

FIG. 3 shows a bio-model according to an embodiment of the present invention. In the embodiment shown in FIG. 3, the sensor 300 is embedded in the bio-model 100 which simulates a patients head. In this example, the bio-model 100 is a single piece. A probe 201 is detected by the sensor 300 which may be, for example a proximity sensor. Data captured by the sensor 300 is transmitted to a computer 200.

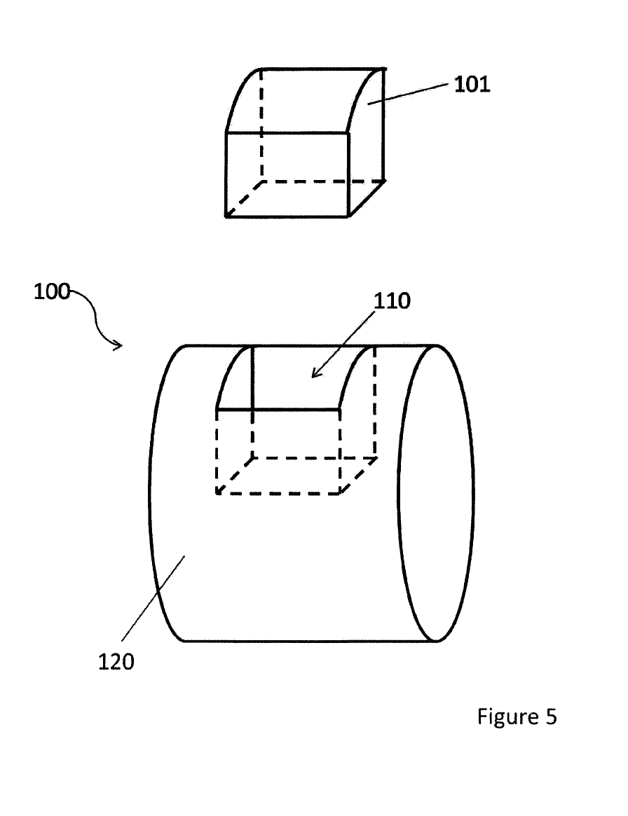

FIG. 4 shows a bio-model according to an embodiment of the present invention. The bio-model 101 is an insert which fits into a slot in a base piece. The configuration of the base piece is described in more detail below with reference to FIG. 5. The bio-model 101 includes a sensor 300 which detects characteristics of a simulated surgical procedure, for example the proximity of a probe 300. The sensor 300 sends signals to a computer 200. The connection between the sensor 300 and the computer 200 may be a wired connection or a wireless connection.

In an embodiment, the bio-model 101 is an insert which fits into a slot in a base piece. This is shown in FIG. 5.

FIG. 5 shows a bio-model according to an embodiment of the present invention which comprises a base piece and an insert. The insert 101 is as described above in relation to FIGS. 1, 2 and 4. As described above, the sides of the insert may be formed as walls. The base piece 120 has a slot 110 into which the insert 101 can be fitted.

The exterior surface of the base piece 120 has contours and features which correspond to the exterior of part of the body. For example, the base piece may include the contours and features of a human torso or the facial features of a human head.

While the exterior of the base piece 120 is shaped to simulate the corresponding parts of the human anatomy, the interior structure is not. The interior of the base piece 120 may be solid or hollow. During a simulated surgical procedure the insert 101 provides a simulation of the interior structure of the body being operated on. The base piece 120 provides a simulation of the exterior of the patient.

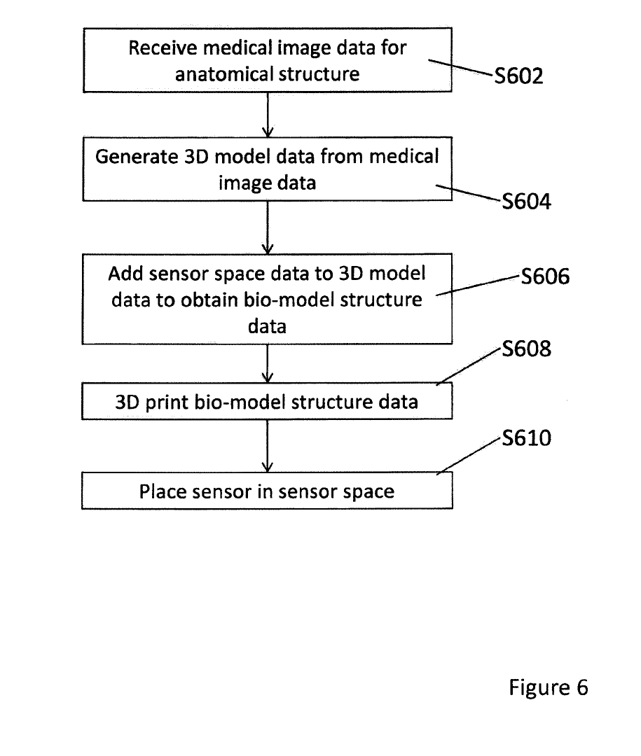

During many surgical procedures, surgical navigation systems are used by the surgeon for guidance. An example of a surgical navigation system is the Medtronic StealthStation S7 System. Such navigation systems use optical navigation to determine locations on a patient's body. The base piece 120 and insert 101 may be produced using scan data from a patient as described below with reference to FIG. 6 in more detail. Since the exterior surface of the base piece 120 will correspond to this scan data, the base piece 120 provides an accurate simulation of the surgical procedure using the navigation system.

The insert 101 includes a top layer of synthetic skin to simulate the skin of the patient during the simulated surgical procedure. During simulation of the surgical procedure, the surgeon will cut an incision or insert a probe through this skin layer. In addition, the surgeon may cut or alter the internal structure of the insert 101. Therefore, the insert 101 can normally only be used for one simulated surgical procedure and is then discarded. Since no changes are made to the base piece 120, it can be reused when the simulation is repeated, for example if the surgeon wishes to practice the same procedure a number of times or to alter certain aspects during planning of a surgical procedure. Therefore the amount of the model which is discarded can be reduced by providing a base piece which can be reused.

FIG. 6 is a flow chart showing a method of manufacturing a bio-model according to an embodiment of the present invention. The method shown in FIG. 6 may be carried out using a computer and a three dimensional printer.

In step S602, medical image data for an anatomical structure is received by the computer. The medical image data may be stored data obtained from a medical imaging apparatus such as a magnetic resonance imaging (MRI) apparatus, a computed tomography (CT) apparatus, an X-ray imaging apparatus, or an ultrasound imaging apparatus. The medical image data may be in the Digital Imaging and Communications (DICOM) format.

The medical image data received in step S602 may be segmented, that is, the various layers and tissues in the images may be labelled. This labelling may be implemented automatically using image analysis, or the images may be segmented manually by an operator.

In step S604, three dimensional model data is generated from the medical image data. The three dimensional model data is generated using a 3D conversion algorithm which generates three dimensional surfaces from the medical image data. Algorithms such as the marching cube algorithm, Delaunay's triangulation algorithm or a combination of the two may be used. The result of step S604 is a three dimensional model of the anatomical structure.

In step S606, sensor space data is added to the three dimensional model of the anatomical structure. The sensor space data indicates the locations of a sensor or a plurality of sensors in the bio-model. The sensor space data may be added using computer aided design (CAD) software.

The locations of the sensors placed in the anatomical structures and the design may differ in accordance to the size and weight of the anatomical structures that it attaches to. The size and location of the sensor spaces may vary based on the anatomical structures that will be produced and the relevant material that the anatomical structures will hold or contain.

The positioning of the sensors in and around the anatomical structure is also selected based on the surgical procedure to be simulated. It is noted that while the anatomical structure is an accurate representation of part of the human anatomy, sensor or sensors are not. Therefore the sensors are located in positions which interfere with the simulated surgical procedure. During the simulated surgical procedure, an incision would be made through the synthetic skin layer to expose part of the anatomical structure. The arrangement of the sensors in the bio-model 100 would be designed so that the sensors which do not correspond to anatomically correct features would not be exposed during the simulated surgical procedure.

The sensors applied in the bio-model 100 may be positioned according to referral to the relevant professionals. The variations in the position of the sensors may be determined by the procedure or by the advice of the relevant professional as it is not to interrupt with the function of the bio-model.

The positioning of the sensors may be standardized. For example, for a particular type of surgical simulation the locations and sizes of the sensor spaces may be stored and then added to medical image data corresponding to a particular patient. Alternatively, the positioning of the sensors may be customized in accordance to the function of the bio-model 100. The position of the sensors may be varied in relation to any variations that occur in the medical image data obtained as any foreign objects such as tumours or abnormalities on the anatomical structure or bio-model 100 may change the positioning of the sensors

In step S608, the bio-model 100 is printed using three dimensional printing. The shape of the anatomical structure and materials to be used for each anatomical region can be predetermined in the 3D data. By this way of predetermination and modification, accurate shape and material can be assigned to each anatomical region, beneficial specifically for pre-surgical training, surgical simulation and surgical training.

In one embodiment, the bio-model including the synthetic anatomical structure may be 3D printed together as a single structure using additive manufacturing technology. Alternatively, the bio-model 100 may be printed as a number of separate parts which are assembled. The sensor spaces are produced within the bio-model. If the sensors are wired sensors, tracks for the wires may also be provided in the bio-model.

In step S610, the sensor is placed in the sensor space. The sensor or sensors may be placed after the bio-model is three dimensional printed. In an embodiment, the sensors may be embedded in the bio-model during the three dimensional printing.

In an embodiment, the 3D data is subjected to a rapid additive manufacturing technique where layers of material are added upon one another to form the 3D anatomical structure. The rapid additive manufacturing techniques used to produce the bio-model 100 may include layered manufacturing, direct digital manufacturing, laser processing, electron beam melting, aerosol jetting, inkjet printing or semi-solid free-form fabrication. The 3D data enables the rapid additive manufacturing machine to sequentially build up many thin layers upon another to build the 3D bio-model.

As described above, embodiments of the present invention provide a bio-model with a sensor or sensors that allow characteristics of a simulated surgical procedure to be monitored and recorded. The bio-model is produced using medical image data and there provides a 3D model that accurately simulates the actual anatomical structure.

1. A three dimensional bio-model for simulating a simulated surgical procedure, the bio-model comprising
a synthetic anatomical structure; and
a sensor arranged to sense a quantity indicative of a characteristic of the simulated surgical procedure.

2. The three dimensional bio-model according to claim 1, wherein the sensor is a proximity sensor.

3. The three dimensional bio-model according to claim 1, wherein the sensor is a motion sensor.

4. The three dimensional bio-model according to claim 1, wherein the sensor is a pressure sensor.

5. The three dimensional bio-model according to claim 1, wherein the sensor is a leakage sensor configured to sense leakage of a fluid within the synthetic anatomical structure.

6. The three dimensional bio-model according to claim 1, wherein the sensor is arranged in a sensor space within the synthetic anatomical structure.

7. The three dimensional bio-model according to claim 1, wherein the sensor comprises a wireless interface configured to generate a signal indicating the quantity indicative of the characteristic of the simulated surgical procedure.

8. The three dimensional bio-model according to claim 1, wherein the sensor is coupled to a wire and the synthetic anatomical structure comprises a pathway for the wire.

9. The three dimensional bio-model according to claim 1 configured to be insertable into a slot in a base piece.

10. The three dimensional bio-model according to claim 1, comprising a base piece and an insert, the base piece defining a slot, the insert being configured to fit into the slot, the insert comprising the synthetic anatomical structure and the scaffold.

11. The three dimensional bio-model according to claim 10, the surface of the base piece having contours and/or features selected to mimic an external anatomy.

12. A method of manufacturing a three dimensional bio-model, the method comprising
receiving medical image data for an anatomical structure;
generating three dimensional model data for the anatomical structure from the medical image data;
generating bio-model structure data from the three dimensional structure data;
three dimensional printing the bio-model structure data to provide a three dimensional bio-model structure; and
placing a sensor in the three dimensional bio-model structure.

13. The method according to claim 12, wherein generating bio-model structure data from the three dimensional structure data comprises adding sensor space data to the three dimensional structure data, the sensor space data indicating a sensor space in the three dimensional bio-model structure.

14. The method according to claim 12, wherein the medical image data is segmented medical image data comprising indications of parts of the anatomical structure.

15. The method according to claim 12, wherein the bio-model structure data comprises structure data for a plurality of bio-model parts, and three dimensional printing the bio-model structure data comprises three dimensional printing each of the plurality of bio-model parts separately, the method further comprising assembling the bio-model parts to form the bio-model.
